(19) United States
(12) Patent Application Publication
(10) Pub. No.: US 2026/0088849 A1
(43) Pub. Date: Mar. 26, 2026

(54) RADIO FREQUENCY EXPOSURE CONTROL USING DYNAMIC ABSORPTION LIMITS BASED ON NON-COLOCATED ANTENNA CLUSTER SEPARATION DISTANCE

(71) Applicant: APPLE INC., Cupertino, CA (US)

(72) Inventors: Sharad Sambhwani, San Diego, CA (US); Dirk Nickisch, Oberpframmern, Bavaria-Bayern (DE)

(21) Appl. No.: 18/895,884

(22) Filed: Sep. 25, 2024

(51) Int. Cl. H04B 1/3827

(52) U.S. Cl. CPC H04B 1/3838

(57) ABSTRACT

Systems and methods for radio frequency exposure control using dynamic absorption limits based on non-colocated antenna cluster separation distance are discussed herein. A user equipment (UE) performs first data transmission using a first antenna cluster during a first portion of an RF exposure duration that uses up to a maximum RF exposure limit per RF exposure duration. Further, the UE performs second data transmission using a second antenna cluster during a second portion of the first RF exposure duration that (also) uses up to the maximum RF exposure limit per RF exposure duration. A separation distance between the first antenna cluster and the second antenna cluster meets a minimum threshold for the use of the maximum RF exposure limit per RF exposure duration at each of the first antenna cluster and the second antenna cluster during the first RF exposure duration.

### TECHNICAL FIELD

This application relates generally to wireless communication systems, including wireless communication systems using transmitters operating under dynamic absorption limits based on transmitter antenna cluster separation distances.

### BACKGROUND

Wireless mobile communication technology uses various standards and protocols to transmit data between a base station and a wireless communication device. Wireless communication system standards and protocols can include, for example, 3rd Generation Partnership Project (3GPP) Long Term Evolution (LTE) (e.g., 4G), 3GPP New Radio (NR) (e.g., 5G), and Institute of Electrical and Electronics Engineers (IEEE) 802.11 standard for Wireless Local Area Networks (WLAN) (commonly known to industry groups as Wi-Fi^{®}).

As contemplated by the 3GPP, different wireless communication systems' standards and protocols can use various radio access networks (RANs) for communicating between a base station of the RAN (which may also sometimes be referred to generally as a RAN node, a network node, or simply a node) and a wireless communication device known as a user equipment (UE). 3GPP RANs can include, for example, Global System for Mobile communications (GSM), Enhanced Data Rates for GSM Evolution (EDGE) RAN (GERAN), Universal Terrestrial Radio Access Network (UTRAN), Evolved Universal Terrestrial Radio Access Network (E-UTRAN), and/or Next-Generation Radio Access Network (NG-RAN).

Each RAN may use one or more radio access technologies (RATs) to perform communication between the base station and the UE. For example, the GERAN implements GSM and/or EDGE RAT, the UTRAN implements Universal Mobile Telecommunication System (UMTS) RAT or other 3GPP RAT, the E-UTRAN implements LTE RAT (sometimes simply referred to as LTE), and NG-RAN implements NR RAT (sometimes referred to herein as 5G RAT, 5G NR RAT, or simply NR). In certain deployments, the E-UTRAN may also implement NR RAT. In certain deployments, NG-RAN may also implement LTE RAT.

A base station used by a RAN may correspond to that RAN. One example of an E-UTRAN base station is an Evolved Universal Terrestrial Radio Access Network (E-UTRAN) Node B (also commonly denoted as evolved Node B, enhanced Node B, eNodeB, or eNB). One example of an NG-RAN base station is a next generation Node B (also sometimes referred to as a g Node B or gNB).

A RAN provides its communication services with external entities through its connection to a core network (CN). For example, E-UTRAN may utilize an Evolved Packet Core (EPC) while NG-RAN may utilize a 5G Core Network (5GC).

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 illustrates a diagram for antenna clustering in a UE having various antennas that can be used by the UE to perform transmission, according to embodiments discussed herein.

FIG. 2 illustrates a diagram for an embodiment for independent uses of a SAR average value limit at each of a first antenna cluster and a second antenna cluster of a UE.

FIG. 3 illustrates a diagram for an embodiment for independent uses of a SAR average value limit at each of a first antenna cluster and a second antenna cluster of a UE.

FIG. 4 illustrates a diagram for an embodiment for independent uses of a SAR average value limit at each of a first antenna cluster and a second antenna cluster of a UE.

FIG. 5 illustrates a diagram for an embodiment for independent uses of a SAR average value limit at each of a first antenna cluster and a second antenna cluster of a UE.

FIG. 6 illustrates a diagram for an embodiment for independent uses of a SAR average value limit at each of a first antenna cluster and a second antenna cluster of a UE.

FIG. 7 illustrates a method of a UE, according to embodiments discussed herein.

FIG. 8 illustrates an example architecture of a wireless communication system, according to embodiments disclosed herein.

FIG. 9 illustrates a system for performing signaling between a wireless device and a network device, according to embodiments disclosed herein.

### DETAILED DESCRIPTION

Various embodiments are described with regard to a UE. However, reference to a UE is merely provided for illustrative purposes. The example embodiments may be utilized with any electronic component that may establish a connection to a network and is configured with the hardware, software, and/or firmware to exchange information and data with the network. Therefore, the UE as described herein is used to represent any appropriate electronic component.

In various wireless communication systems, it is important to ensure that device-generated radio frequency (RF) exposure event(s) that impact a user do not exceed RF exposure limits (e.g., as may be defined by applicable regulatory bodies). Without remaining within these RF exposure limits, the offending elements of the wireless communication system are at risk of harming users and/or becoming subject to regulatory action.

Due to the temporal nature of RF communications, it may be that such RF exposure limits are understood in terms of an applicable duration of time over which the RF exposure limit applies. Corresponding to such cases, this disclosure may accordingly refer to “a maximum RF exposure limit per RF exposure duration.” Note that in some alternative cases this disclosure may instead refer more simply to “a maximum RF exposure limit” or an “RF exposure limit” or the like, which should, in applicable circumstances, be understood to incorporate the notion that the limit is on a per RF exposure duration basis.

One type of an RF exposure limit is a specific absorption rate (SAR) average value limit. A SAR average value represents an average absorption rate of RF energy with the person of the user during an applicable RF exposure duration. A SAR average value limit may represent an upper permissible limit on the average value for this absorption rate over the RF exposure duration. Such SAR average values (and corresponding limits therefor) may be denoted in terms of Watts per kilogram (W/kg).

A SAR average value may be determined experimentally by placing a transmitting device (e.g., a UE) in position with respect to a mannequin that is designed to represent human physiology. The positioning of the device and with respect to the mannequin and/or the design of the mannequin itself may be arranged to correspond to an expected use case for the device. The device is then operated, and sensors within the mannequin take measurements corresponding to this operation that are then used calculate the SAR average value attributable to the operation of the device.

Another type of an RF exposure limit is a maximum permissible exposure (MPE) average value limit. The power density of RF energy broadcast by a transmitter over an RF exposure duration may be measured over an RF exposure duration, and these measurements may then be used to determine an average power density over the RF exposure duration. An MPE average value limit may represent an upper permissible limit on this average power density over the RF exposure duration. Such average power density measurements (and corresponding MPE average value limits therefor) may be denoted in terms of Watts per square meter (W/m²).

Compliance with such RF exposure limits may result in a transmit (Tx) power reduction at the device to a power level that is lower than what is otherwise achievable/possible with the device. In the case of a UE, this may result in reduced uplink (UL) coverage for the UE, impacts on throughput, and/or impacts on voice quality, etc.

Embodiments herein relate to cases where antennas/panels of a single device are sufficiently spatially separated that they can be fairly treated separately when taking into account applicable RF exposure limits (e.g., as each using its own independent RF exposure limit rather than jointly operating within the bounds of a single, shared RF exposure limit). In other words, embodiments herein relate to cases where non-colocated antennas of a device can be viewed separably from the RF exposure/RF exposure limit perspective.

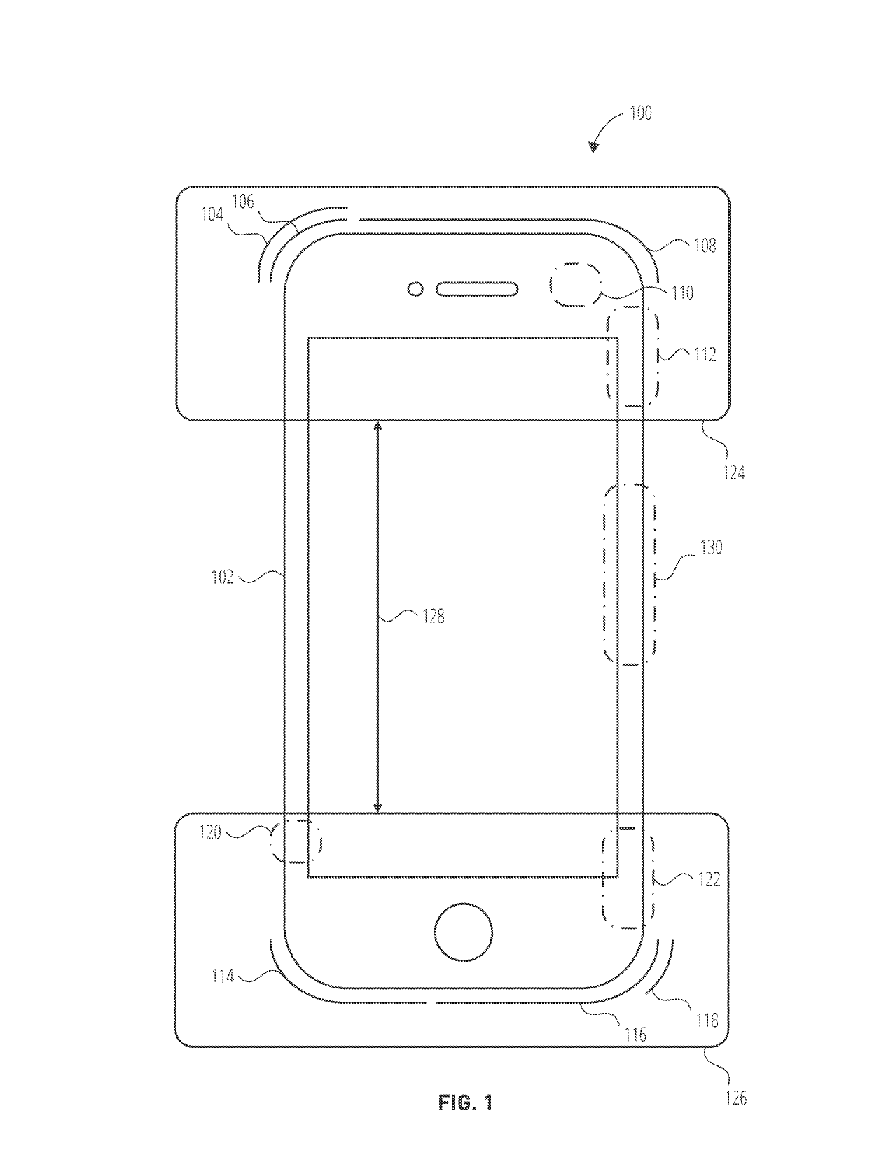

FIG. 1 illustrates a diagram 100 for antenna clustering in a UE 102 having various antennas that can be used by the UE to perform transmission, according to embodiments discussed herein. Specifically, as illustrated, the UE 102 includes the first antenna 104, the second antenna 106, the third antenna 108, the fourth antenna 110, the fifth antenna 112, the sixth antenna 114, the seventh antenna 116, the eighth antenna 118, the ninth antenna 120, and the tenth antenna 122.

As discussed herein, an antenna cluster may represent a grouping of one or more existing antennas of a UE according to physical proximity. For example, with respect to the UE 102 of FIG. 1 it may be considered that the first antenna 104, the second antenna 106, the third antenna 108, the fourth antenna 110, and the fifth antenna 112 make up a first antenna cluster 124 due to their physical proximity. It may accordingly be understood that a transmission using any one or more of the first antenna 104, the second antenna 106, the third antenna 108, the fourth antenna 110, and/or the fifth antenna 112 is a transmission of/by the first antenna cluster 124.

Further, due to their physical proximity, it may be considered that the sixth antenna 114, the seventh antenna 116, the eighth antenna 118, the ninth antenna 120, and the tenth antenna 122 make up a second antenna cluster 126 due to their physical proximity. It may accordingly be understood that a transmission using any one or more of the sixth antenna 114, the seventh antenna 116, the eighth antenna 118, the ninth antenna 120, and/or the tenth antenna 122 is a transmission of/by the second antenna cluster 126.

As discussed herein, a separation distance may represent an amount of physical separation/distance between antenna clusters. For example, with respect to the UE 102 of FIG. 1, the first antenna cluster 124 and the second antenna cluster 126 are spatially separated by a separation distance 128.

In some UEs, antenna clusters as may be used by the UE have a sufficient physical separation such that their RF exposure characteristics (e.g., SAR exposure characteristics) at each of the antenna clusters can fairly be considered non-overlapping. With respect to such cases, it has been determined that the separate antenna clusters may thus be considered as independent transmission sources for purposes of making corresponding RF exposure limit determinations.

Embodiments herein accordingly relate to cases where a separation distance between antenna clusters of a (single) device meets a minimum threshold that allows for the independent use of the maximum RF exposure limit per RF exposure duration at each of the antenna clusters during a (same) RF exposure duration. This is opposed to a case where, for example, all transmissions (across all antenna clusters) are jointly bound within a single maximum RF exposure limit per RF exposure duration.

For example, with reference to FIG. 1, suppose that the separation distance 128 is sufficient such that SAR exposure characteristics of the first antenna cluster 124 and the second antenna cluster 126 may fairly be considered non-overlapping (e.g., for purposes of determining compliance by the UE 102 with regulatory SAR average value limits). In such a case, transmissions at each of the first antenna cluster 124 and the second antenna cluster 126 may (independently) consume up to the SAR average value limit during a single RF exposure duration (as opposed to a case where all transmissions across both of the first antenna cluster 124 and the second antenna cluster 126 are jointly kept within that SAR average value limit during the RF exposure duration).

Supposing, for example, that the SAR average value limit is 1 W/kg, this means that each of the first antenna cluster 124 and the second antenna cluster 126 cluster can utilize up to 1 W/kg SAR on average during the RF exposure duration. This is opposed to a case where the 1 W/kg SAR on average during the RF exposure duration is instead shared between both the first antenna cluster 124 and the 126 (e.g., with each of the first antenna cluster 124 and the second antenna cluster 126 being limited to 0.5 W/kg SAR on average during the RF exposure duration).

It is noted that the particular arrangement of the first antenna 104, the second antenna 106, the third antenna 108, the fourth antenna 110, and the fifth antenna 112 as within of the first antenna cluster 124 and sixth antenna 114, the seventh antenna 116, the eighth antenna 118, the ninth antenna 120, and the tenth antenna 122 as within the second antenna cluster 126 as illustrated in relation to the UE 102 of FIG. 1 is given by way of example and not by way of limitation. Corresponding to embodiments discussed herein, any one or more antennas of a device may be identified to be within an antenna cluster for that device. Corresponding separation distances between such clusters would accordingly be determinable.

It is also noted that there is no requirement that every antenna of a device be considered as part of any applicable antenna cluster. For example, the diagram 100 illustrates an eleventh antenna 130 that is not part of either of the first antenna cluster 124 or the second antenna cluster 126 (and accordingly is not applicable/not used for the transmissions of the first antenna cluster 124 and/or the second antenna cluster 126 discussed herein).

In some embodiments, a UE may identify/determine the antenna-wise makeup of the antenna clusters under consideration. as described herein. In some embodiments, a UE may identify a separation distance between antenna clusters and then proceed to identify whether the separation distance meets the minimum threshold for the independent use of the maximum RF exposure limit per RF exposure duration at each of the antenna clusters.

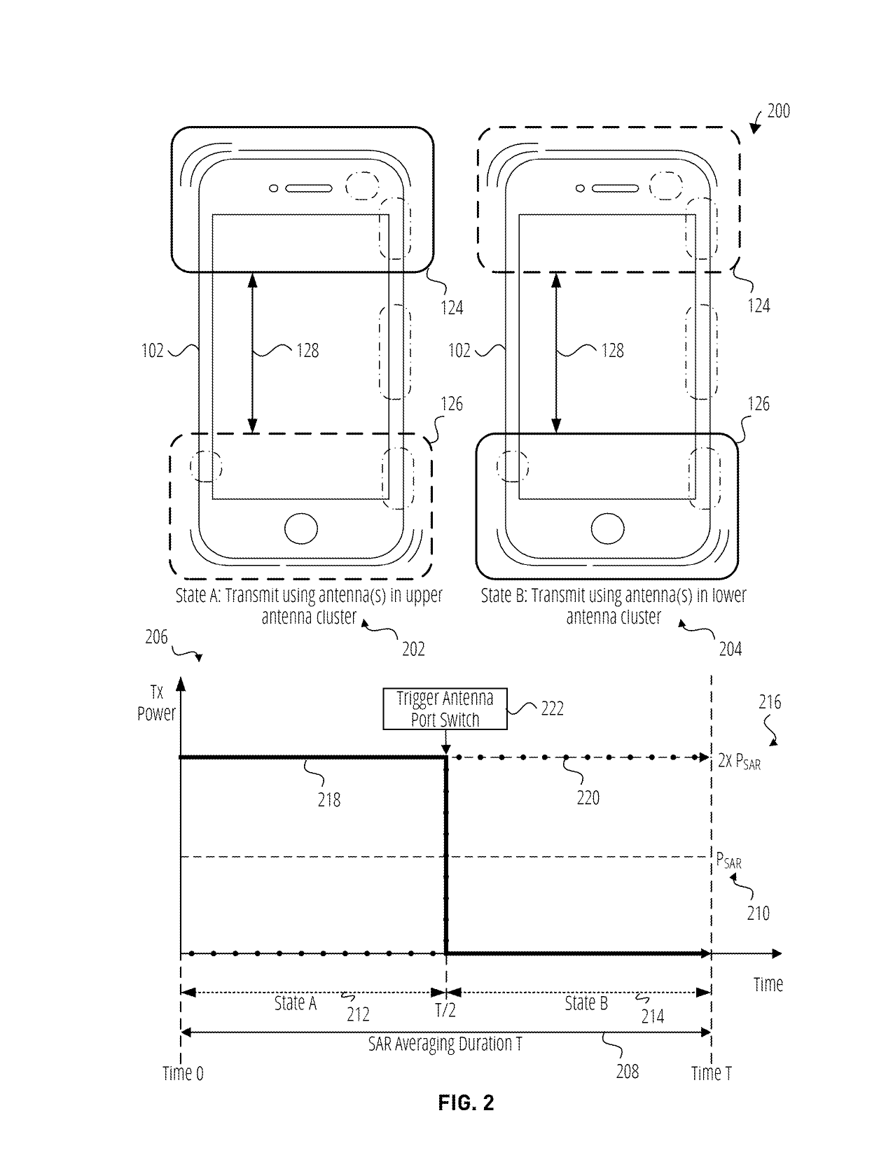

FIG. 2 illustrates a diagram 200 for an embodiment for independent uses of a SAR average value limit at each of the first antenna cluster 124 and the second antenna cluster 126 of the UE 102.

To facilitate the discussion of these aspects with respect to FIG. 2, the diagram 200 illustrates that during a first transmission state 202 for the UE 102, the UE 102 uses the first antenna cluster 124 (e.g., any one or more of the antennas of the first antenna cluster 124) to perform transmissions while the second antenna cluster 126 does not perform transmission. Further, during a second transmission state 204 for the UE 102, the UE 102 uses the second antenna cluster 126 (e.g., any one or more of the antennas of the second antenna cluster 126) to perform transmission while the first antenna cluster 124 does not perform transmission.

The diagram 200 further illustrates a timeline for this behavior in terms of a Tx power graph 206. The Tx power graph 206 illustrates a use of antenna port switching 222 that is used to transition between the use of the first antenna cluster 124 and the use second antenna cluster 126.

Note generally that the diagram 200 corresponds to the case that each of the first antenna cluster 124 and the second antenna cluster 126 is understood to be operable according to independent (non-overlapping) SAR average value limits due to a sufficient separation distance 128 between the first antenna cluster 124 and the second antenna cluster 126.

The Tx power graph 206 illustrates a SAR averaging duration 208 (denoted T) which may be understood as the applicable Rx exposure duration for purposes of the SAR-related determinations under discussion with respect to FIG. 2. Note that in some embodiments, the SAR averaging duration 208 may be equal to 100 seconds. Within the Tx power graph 206, a Tx power level P_{SAR}210 that corresponds to the SAR average value limit for the SAR averaging duration 208 that applies at each of the first antenna cluster 124 and the second antenna cluster 126 is illustrated. The P_{SAR}210 is a power level that, if fully used by one or the other of the first antenna cluster 124 or the second antenna cluster 126 to perform transmission during the entire SAR averaging duration 208, would meet the SAR average value limit for the SAR averaging duration 208 for that antenna cluster.

The Tx power graph 206 illustrates a first antenna cluster transmission power 218 and a second antenna cluster transmission power 220 as used over the SAR averaging duration 208. The Tx power graph 206 illustrates a case where each of the first antenna cluster 124 and the second antenna cluster 126 transmits during half of the SAR averaging duration 208 and does not perform transmission during the other half of the SAR averaging duration 208. Accordingly, as illustrated, it will be understood that the UE 102 will be in the first transmission state 202 (using the first antenna cluster 124 for transmission) during a first portion 212 of the SAR averaging duration 208 from time 0 to time T/2. An antenna port switching 222 from the first antenna cluster 124 to the second antenna cluster 126 is then triggered, with the result that the UE 102 will be in the second transmission state 204 (using the second antenna cluster 126 for transmission) during a second portion 214 of the SAR averaging duration 208 from time T/2 to time T.

As previously explained, because there is a sufficient separation distance 128 between the first antenna cluster 124 and the second antenna cluster 126, each of the first antenna cluster 124 and the second antenna cluster 126 can independently use up to the SAR average value limit during the SAR averaging duration 208. For example, in the case that the SAR average value limit is 1 W/kg, each of the first antenna cluster 124 and the second antenna cluster 126 can independently use up to 1 W/kg on average over the SAR averaging duration 208.

Accordingly, due to the fact that each of the first antenna cluster 124 and the second antenna cluster 126 only actually transmit during their respective half of the SAR averaging duration 208 (instead of over the entire SAR averaging duration 208), each of the first antenna cluster transmission power 218 and the second antenna cluster transmission power 220 can operate at a 2x P_{SAR}216 power level over the course of their respective halves of the SAR averaging duration 208, as illustrated.

Note that under these circumstances, each of the first antenna cluster 124 and the second antenna cluster 126 has been independently operated within the constraints of the SAR average value limit when considered over the course of the entire applicable SAR averaging duration 208.

The operation of the first antenna cluster 124 and the second antenna cluster 126 at the 2x P_{SAR}216 power level corresponds to a 3 decibel (dB) Tx power increase relative to a use of the P_{SAR}210 power level. This 3 dB increase translates to an up to 100% higher uplink (UL) throughput during the portion of the SAR averaging duration 208 during which that cluster is active than would otherwise be achieved in the case of an overlapped SAR average value limit that applies jointly to both the first antenna cluster 124 and the second antenna cluster 126.

Accordingly, it will be understood that through the use of the antenna port switching 222 between the first antenna cluster 124 and the second antenna cluster 126 as illustrated in FIG. 2, the UE 102 can maximize the use of SAR average values at each of the first antenna cluster 124 and the second antenna cluster 126 as available within each of the independent uses of the SAR average value limit for each of the first antenna cluster 124 and the second antenna cluster 126. Accordingly, the UE 102 experiences relatively improved UL Tx characteristics (improved/additional power and correspondingly UL throughput).

Finally, note that under the described arrangement, there is no need for Tx “downtime” within the SAR averaging duration 208 in order to remain compliant with the SAR average value limit at each of the first antenna cluster 124 and the second antenna cluster 126.

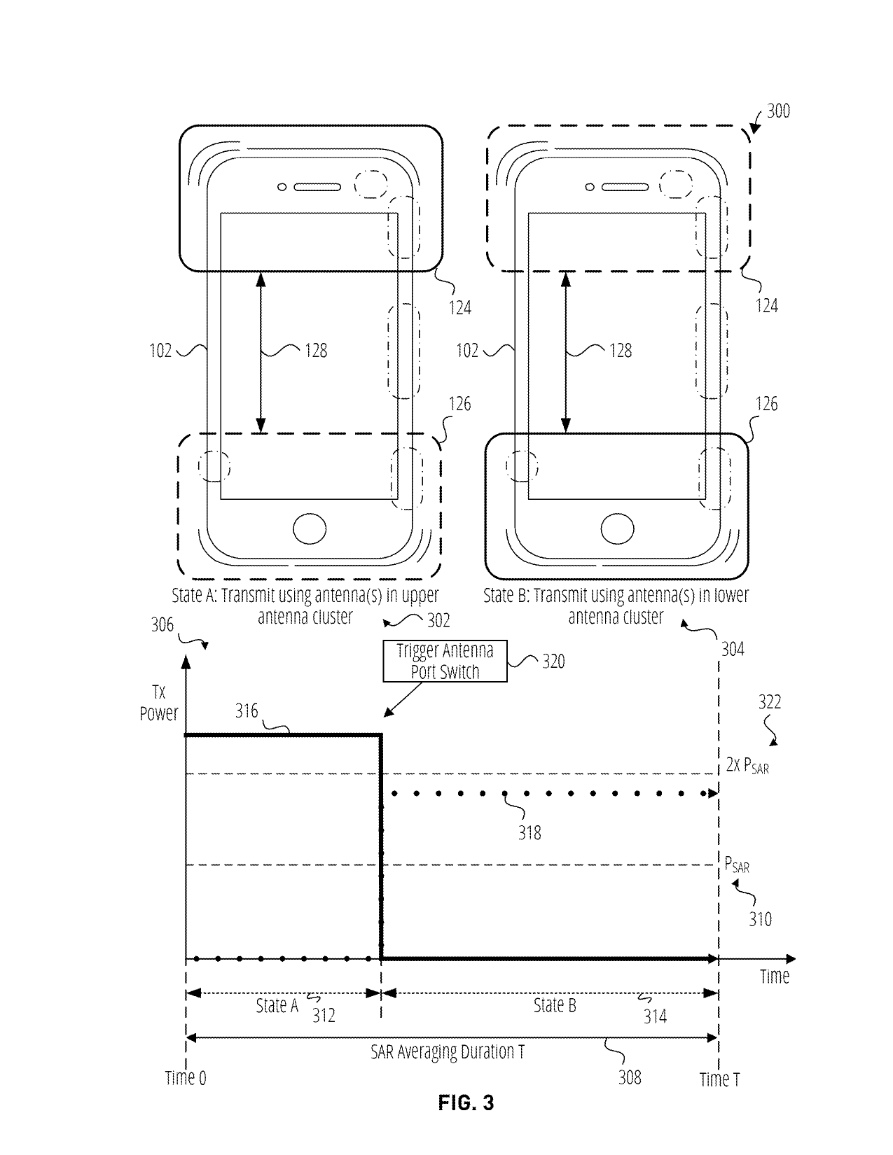

FIG. 3 illustrates a diagram 300 for an embodiment for independent uses of a SAR average value limit at each of the first antenna cluster 124 and the second antenna cluster 126 of the UE 102.

To facilitate the discussion of these aspects with respect to FIG. 3, the diagram 300 illustrates that during a first transmission state 302 for the UE 102, the UE 102 uses the first antenna cluster 124 (e.g., any one or more of the antennas of the first antenna cluster 124) to perform transmissions while the second antenna cluster 126 does not perform transmission. Further, during a second transmission state 304 for the UE 102, the UE 102 uses the second antenna cluster 126 (e.g., any one or more of the antennas of the second antenna cluster 126) to perform transmission while the first antenna cluster 124 does not perform transmission.

The diagram 300 further illustrates a timeline for this behavior in terms of a Tx power graph 306. The Tx power graph 306 illustrates a use of antenna port switching 320 that is used to transition between the use of the first antenna cluster 124 and the use second antenna cluster 126.

Note generally that the diagram 300 corresponds to the case that each of the first antenna cluster 124 and the second antenna cluster 126 is understood to be operable according to independent (non-overlapping) SAR average value limits due to a sufficient separation distance 128 between the first antenna cluster 124 and the second antenna cluster 126.

The Tx power graph 306 illustrates a SAR averaging duration 308 (denoted T) which may be understood as the applicable Rx exposure duration for purposes of the SAR-related determinations under discussion with respect to FIG. 3. Note that in some embodiments, the SAR averaging duration 308 may be equal to 100 seconds. Within the Tx power graph 306, a Tx power level P_{SAR}310 that corresponds to the SAR average value limit for the SAR averaging duration 308 that applies at each of the first antenna cluster 124 and the second antenna cluster 126 is drawn. The P_{SAR}310 is a power level that, if fully used by one or the other of the first antenna cluster 124 or the second antenna cluster 126 to perform transmission during the entire SAR averaging duration 308, would meet the SAR average value limit for the SAR averaging duration 308 for that antenna cluster.

The Tx power graph 306 illustrates a first antenna cluster transmission power 316 and a second antenna cluster transmission power 318 as used over the SAR averaging duration 308. The Tx power graph 306 illustrates a case where the first antenna cluster 124 transmits during a first portion 312 of the SAR averaging duration 308 and does not perform transmission during a second portion 314 of the SAR averaging duration 308. Further, the second antenna cluster 126 does not transmit during the first portion 312 of the SAR averaging duration 308 and then performs transmission during the second portion 314 of the SAR averaging duration 308. An antenna port switching 320 between the first antenna cluster 124 and the second antenna cluster 126 facilitates the corresponding UE state switch between the first transmission state 302 and the second transmission state 304.

As previously explained, because there is a sufficient separation distance 128 between the first antenna cluster 124 and the second antenna cluster 126, each of the first antenna cluster 124 and the second antenna cluster 126 can independently use up to the SAR average value limit during the SAR averaging duration 308. For example, in the case that the SAR average value limit is 1 W/kg, each of the first antenna cluster 124 and the second antenna cluster 126 can independently use up to 1 W/kg on average over the SAR averaging duration 308.

As illustrated, the first portion 312 of the SAR averaging duration 308 during which the first antenna cluster 124 transmits is of a duration that is less than half of the SAR averaging duration 308. Accordingly, as shown, the first antenna cluster transmission power 316 can be set to a level that is greater than 2x P_{SAR}322. Because the duration of the first portion 312 is less than half of the SAR averaging duration 308, the SAR average value of this transmission behavior when considered over the course of the entire SAR averaging duration 308 remains within the SAR average value limit for the SAR averaging duration 308 for the first antenna cluster 124.

The second portion 314 of the SAR averaging duration 308 during which the second antenna cluster 126 transmits is of a duration that is more than half and less than all of the SAR averaging duration 308. Accordingly, as shown the second antenna cluster transmission power 318 can be set to a level that is greater than P_{SAR}310 but less than 2x P_{SAR}322. Because the duration of the second portion 314 is greater than half but less than all the SAR averaging duration 308, the SAR average value of this transmission behavior when considered over the course of the SAR averaging duration 308 remains within the SAR average value limit for the SAR averaging duration 308 for the second antenna cluster 126.

The operation of the first antenna cluster 124 at a first antenna cluster transmission power 316 that is higher than that of the second antenna cluster transmission power 318 for the second antenna cluster 126 may be used in cases where, for example, the UE 102 determines that first channel used by the first antenna cluster 124 is has a lower channel quality than that of a second channel used by the second antenna cluster 126. Note that such channel differences can be perceived in cases where, for example, the UE 102 communicates with different target transmission reception points (TRPs) for each of the first antenna cluster 124 and the second antenna cluster 126 and/or where characteristics of the antennas used within each of the first antenna cluster 124 and the second antenna cluster 126 are dissimilar.

Accordingly, it will be understood that through the use of the antenna port switching 320 between the first antenna cluster 124 and the second antenna cluster 126 as illustrated in FIG. 3, the UE 102 can maximize the use of independently-limited SAR average values at each of the first antenna cluster 124 and the second antenna cluster 126 in a way that associates a relatively higher power level to one of the channels (e.g., the channel for the first antenna cluster 124), thereby improving communication throughput and/or reliability for that channel.

Finally, note that under the described arrangement, there is no need for Tx “downtime” within the SAR averaging duration 308 in order to remain compliant with the SAR average value limit at each of the first antenna cluster 124 and the second antenna cluster 126.

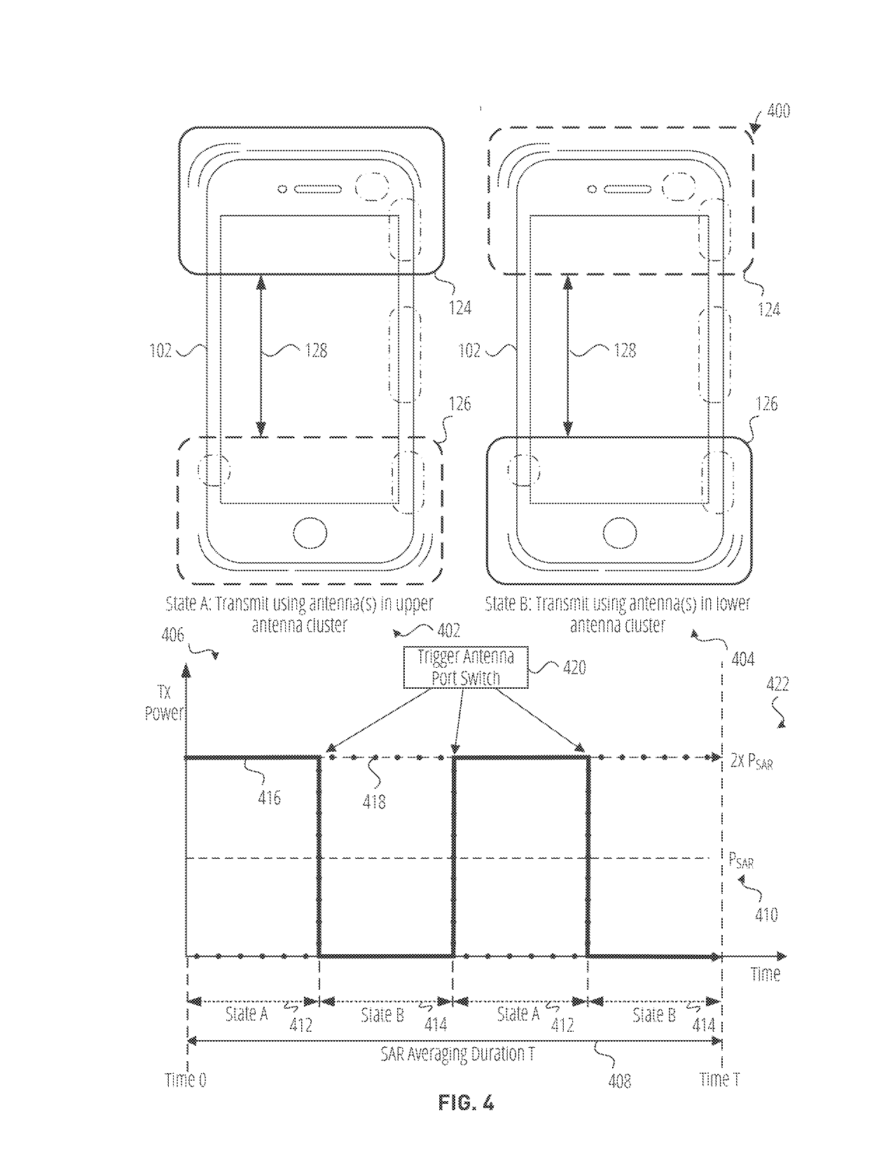

FIG. 4 illustrates a diagram 400 for an embodiment for independent uses of a SAR average value limit at each of the first antenna cluster 124 and the second antenna cluster 126 of the UE 102.

To facilitate the discussion of these aspects with respect to FIG. 4, the diagram 400 illustrates that during a first transmission state 402 for the UE 102, the UE 102 uses the first antenna cluster 124 (e.g., any one or more of the antennas of the first antenna cluster 124) to perform transmissions while the second antenna cluster 126 does not perform transmission. Further, during a second transmission state 404 for the UE 102, the UE 102 uses the second antenna cluster 126 (e.g., any one or more of the antennas of the second antenna cluster 126) to perform transmission while the first antenna cluster 124 does not perform transmission.

The diagram 400 further illustrates a timeline for this behavior in terms of a Tx power graph 406. The Tx power graph 406 illustrates a use of antenna port switching 420 that is used to transition between the use of the first antenna cluster 124 and the use second antenna cluster 126.

Note generally that the diagram 400 corresponds to the case that each of the first antenna cluster 124 and the second antenna cluster 126 is understood to be operable according to independent (non-overlapping) SAR average value limits due to a sufficient separation distance 128 between the first antenna cluster 124 and the second antenna cluster 126.

The Tx power graph 406 illustrates a SAR averaging duration 408 (denoted T) which may be understood as the applicable Rx exposure duration for purposes of the SAR-related determinations under discussion with respect to FIG. 4. Note that in some embodiments, the SAR averaging duration 408 may be equal to 100 seconds. Within the Tx power graph 406, a Tx power level P_{SAR}410 that corresponds to the SAR average value limit for the SAR averaging duration 408 that applies at each of the first antenna cluster 124 and the second antenna cluster 126 is drawn. The P_{SAR}410 is a power level that, if fully used by one or the other of the first antenna cluster 124 or the second antenna cluster 126 to perform transmission during the entire SAR averaging duration 408, would meet the SAR average value limit for the SAR averaging duration 408 for that antenna cluster.

The Tx power graph 406 illustrates a first antenna cluster transmission power 416 and a second antenna cluster transmission power 418 used over the SAR averaging duration 408. The Tx power graph 406 illustrates a case where the first antenna cluster 124 transmits during a first portion 412 of the SAR averaging duration 408 and does not perform transmission during a second portion 414 of the SAR averaging duration 408. Further, the second antenna cluster 126 does not transmit during the first portion 412 of the SAR averaging duration 408 and then performs transmission during the second portion 414 of the SAR averaging duration 408.

Note that in this case, the first portion 412 of the SAR averaging duration 408 during which the first antenna cluster 124 transmits is interleaved with the second portion 414 of the SAR averaging duration 408 during which the second antenna cluster 126 transmits. An antenna port switching 420 between the first antenna cluster 124 and the second antenna cluster 126 facilitates the corresponding UE state switches between the first transmission state 402 and the second transmission state 404. This interleaving may be used such that each of the first antenna cluster 124 and the second antenna cluster 126 has access to the ability to transmit on a relatively more frequent basis than simply one single sub-duration of the SAR averaging duration 408.

As previously explained, because there is a sufficient separation distance 128 between the first antenna cluster 124 and the second antenna cluster 126, each of the first antenna cluster 124 and the second antenna cluster 126 can independently use up to the SAR average value limit during the SAR averaging duration 408. For example, in the case that the SAR average value limit is 1 W/kg, each of the first antenna cluster 124 and the second antenna cluster 126 can independently use up to 1 W/kg on average over the SAR averaging duration 408.

In the example shown in FIG. 4, the total duration of each of the first portion 412 and the second portion 414 (as summed across the interleaving just described) is equal to one half of the SAR averaging duration 408. Accordingly, due to the fact that each of the first antenna cluster 124 and the second antenna cluster 126 only actually transmit during their respective half of the SAR averaging duration 408 (instead of over the entire SAR averaging duration 408), each of the first antenna cluster transmission power 416 and the second antenna cluster transmission power 418 can operate at a 2x P_{SAR}422 power level for the SAR averaging duration 408 over the course of their respective portion of the SAR averaging duration 408, as illustrated.

Note that under these circumstances, each of the first antenna cluster 124 and the second antenna cluster 126 has been independently operated within the constraints of the SAR average value limit when considered over the course of the entire applicable SAR averaging duration 408.

The operation of the first antenna cluster 124 and the second antenna cluster 126 at the 2x P_{SAR}422 power level corresponds to a 3 decibel (dB) Tx power relative to a use of the P_{SAR}410 power level. This 3 dB increase translates to an up to 100% higher uplink (UL) throughput during the portion of the SAR averaging duration 408 during which that cluster is active than would otherwise be achieved in the case of an overlapped SAR average value limit that applies jointly to both the first antenna cluster 124 and the second antenna cluster 126.

Accordingly, it will be understood that through the use of the antenna port switching 420 between the first antenna cluster 124 and the second antenna cluster 126 as illustrated in FIG. 4, the UE 102 can maximize the use of SAR average values at each of the first antenna cluster 124 and the second antenna cluster 126 as available within each of the independent uses of the SAR average value limit for each of the first antenna cluster 124 and the second antenna cluster 126. Accordingly, the UE 102 experiences relatively improved UL Tx characteristics (improved/additional power and correspondingly UL throughput). Further, the use of interleaving as illustrated reduces the theoretical maximum duration of time for which one or the other of the first antenna cluster 124 and the second antenna cluster 126 cannot transmit, thereby improving air interface responsiveness.

Finally, note that under the described arrangement, there is no need for Tx “downtime” within the SAR averaging duration 408 in order to remain compliant with the SAR average value limit at each of the first antenna cluster 124 and the second antenna cluster 126.

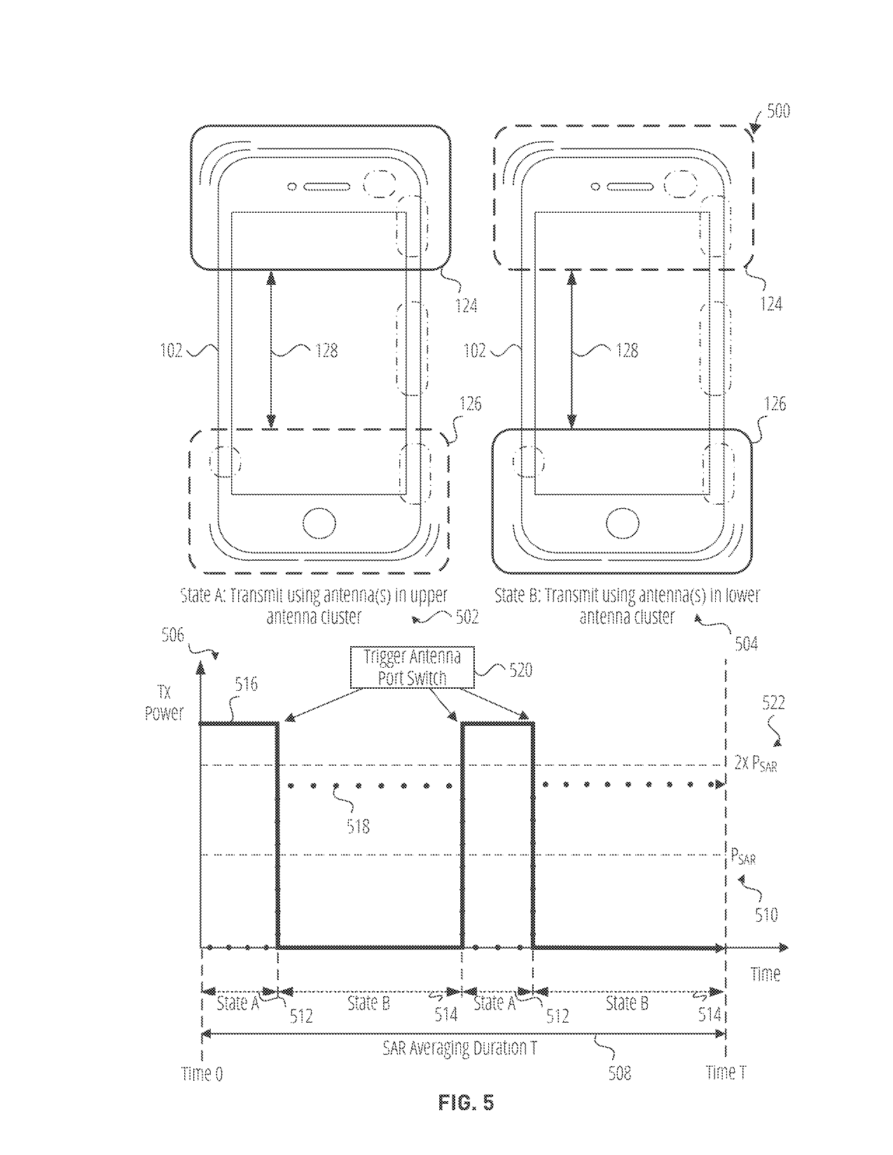

FIG. 5 illustrates a diagram 500 for an embodiment for independent uses of a SAR average value limit at each of the first antenna cluster 124 and the second antenna cluster 126 of the UE 102.

To facilitate the discussion of these aspects with respect to FIG. 5, the diagram 500 illustrates that during a first transmission state 502 for the UE 102, the UE 102 uses the first antenna cluster 124 (e.g., any one or more of the antennas of the first antenna cluster 124) to perform transmissions while the second antenna cluster 126 does not perform transmission. Further, during a second transmission state 504 for the UE 102, the UE 102 uses the second antenna cluster 126 (e.g., any one or more of the antennas of the second antenna cluster 126) to perform transmission while the first antenna cluster 124 does not perform transmission.

The diagram 500 further illustrates a timeline for this behavior in terms of a Tx power graph 506. The Tx power graph 506 illustrates a use of antenna port switching 520 that is used to transition between the use of the first antenna cluster 124 and the use second antenna cluster 126.

Note generally that the diagram 500 corresponds to the case that each of the first antenna cluster 124 and the second antenna cluster 126 is understood to be operable according to independent (non-overlapping) SAR average value limits due to a sufficient separation distance 128 between the first antenna cluster 124 and the second antenna cluster 126.

The Tx power graph 506 illustrates a SAR averaging duration 508 (denoted T) which may be understood as the applicable Rx exposure duration for purposes of the SAR-related determinations under discussion with respect to FIG. 5. Note that in some embodiments, the SAR averaging duration 508 may be equal to 100 seconds. Within the Tx power graph 506, a Tx power level P_{SAR}510 that corresponds to the SAR average value limit for the SAR averaging duration 508 that applies at each of the first antenna cluster 124 and the second antenna cluster 126 is drawn. The P_{SAR}510 is a power level that, if fully used by one or the other of the first antenna cluster 124 or the second antenna cluster 126 to perform transmission during the entire SAR averaging duration 508, would meet the SAR average value limit for the SAR averaging duration 508 for that antenna cluster.

The Tx power graph 506 illustrates a first antenna cluster transmission power 516 and a second antenna cluster transmission power 518 used over the SAR averaging duration 508. The Tx power graph 506 illustrates a case where the first antenna cluster 124 transmits during a first portion 512 of the SAR averaging duration 508 and does not perform transmission during a second portion 514 of the SAR averaging duration 508. Further, the second antenna cluster 126 does not transmit during the first portion 512 of the SAR averaging duration 508 and then performs transmission during the second portion 514 of the SAR averaging duration 508.

Note that in this case, the first portion 512 of the SAR averaging duration 508 during which the first antenna cluster 124 transmits is interleaved with the second portion 514 of the SAR averaging duration 508 during which the second antenna cluster 126 transmits. An antenna port switching 520 between the first antenna cluster 124 and the second antenna cluster 126 facilitates the corresponding UE state switches between the first transmission state 502 and the second transmission state 504. This interleaving may be used such that each of the first antenna cluster 124 and the second antenna cluster 126 has access to the ability to transmit on a relatively more frequent basis that simply one single sub-duration of the SAR averaging duration 508.

As previously explained, because there is a sufficient separation distance 128 between the first antenna cluster 124 and the second antenna cluster 126, each of the first antenna cluster 124 and the second antenna cluster 126 can independently use up to the SAR average value limit during the SAR averaging duration 508. For example, in the case that the SAR average value limit is 1 W/kg, each of the first antenna cluster 124 and the second antenna cluster 126 can independently use up to 1 W/kg on average over the SAR averaging duration 508.

As illustrated, the first portion 512 of the SAR averaging duration 508 during which the first antenna cluster 124 transmits is of a total duration (as summed across the interleaving just described) that is less than half of the SAR averaging duration 508. Accordingly, as shown, the first antenna cluster transmission power 516 can be set to a level that is greater than 2x P_{SAR}522. The SAR average value of this transmission behavior over the course of the entire SAR averaging duration 508 remains within the SAR average value limit for the SAR averaging duration 508.

The second portion 514 of the SAR averaging duration 508 during which the second antenna cluster 126 transmits is of a total duration (as summed across the interleaving just described) that is more than half and less than all of the SAR averaging duration 508. Accordingly, as shown, the second antenna cluster transmission power 518 can be set to a level that is greater than P_{SAR}510 but less than 2x P_{SAR}522. The SAR average value of this transmission behavior over the course of the SAR averaging duration 508 remains within the SAR average value limit for the SAR averaging duration 508.

The operation of the first antenna cluster 124 at a first antenna cluster transmission power 516 that is higher than that of the second antenna cluster transmission power 518 for the second antenna cluster 126 may be used in cases where, for example, the UE 102 determines that first channel used by the first antenna cluster 124 is has a lower channel quality than that of a second channel used by the second antenna cluster 126. Note that such channel differences can be perceived in cases where, for example, the UE 102 communicates with different target TRPs using each of the first antenna cluster 124 and the second antenna cluster 126 and/or where characteristics of the antennas used within each of the first antenna cluster 124 and the second antenna cluster 126 are dissimilar.

Accordingly, it will be understood that through the use of the antenna port switching 520 between the first antenna cluster 124 and the second antenna cluster 126 as illustrated in FIG. 5, the UE 102 can maximize the use of SAR average values at each of the first antenna cluster 124 and the second antenna cluster 126 as available within each of the independent uses of the SAR average value limit for each of the first antenna cluster 124 and the second antenna cluster 126. Accordingly, the UE 102 experiences relatively improved UL Tx characteristics (improved/additional power and correspondingly UL throughput). Further, the use of interleaving as illustrated reduces the theoretical maximum duration of time for which one or the other of the first antenna cluster 124 and the second antenna cluster 126 cannot transmit, thereby improving air interface responsiveness. Still further, this has been done in a way that associates a relatively higher power level to one of the channels (e.g., the channel for the first antenna cluster 124), thereby improving communication throughput and/or reliability for that channel.

Finally, note that under the described arrangement, there is no need for Tx “downtime” within the SAR averaging duration 508 in order to remain compliant with the P_{SAR}510 at each of the first antenna cluster 124 and the second antenna cluster 126.

The examples provided in FIG. 2, FIG. 3, FIG. 4, and FIG. 5 each consider a that a same single P_{SAR} Tx power value for each of the first antenna cluster 124 and the second antenna cluster 126 corresponds to the applicable SAR average value limit across the applicable SAR averaging duration. However, it may be the case that each of the first antenna cluster 124 and the second antenna cluster 126 has different SAR characteristics (e.g., due to differing arrangements, populations, and/or structures of antennas, and/or due to differing antenna cluster locations within the UE 102 relative to the user). In such cases, the P_{SAR} value that corresponds to the SAR average value limit across the applicable SAR averaging duration at each of the first antenna cluster 124 and the second antenna cluster 126 may be different.

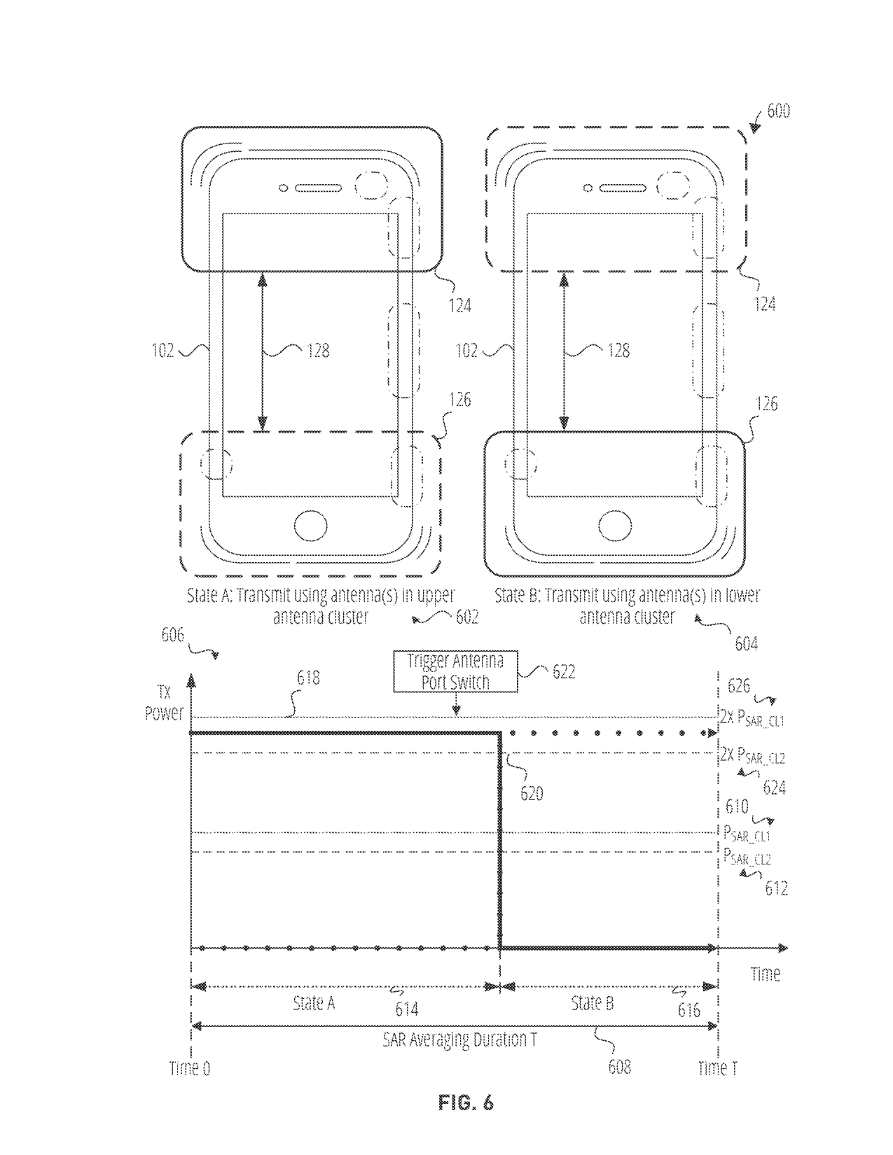

FIG. 6 illustrates a diagram 600 for an embodiment for independent uses of a SAR average value limit at each of the first antenna cluster 124 and the second antenna cluster 126 of the UE 102.

To facilitate the discussion of these aspects with respect to FIG. 6, the diagram 600 illustrates that during a first transmission state 602 for the UE 102, the UE 102 uses the first antenna cluster 124 (e.g., any one or more of the antennas of the first antenna cluster 124) to perform transmissions while the second antenna cluster 126 does not perform transmission. Further, during a second transmission state 604 for the UE 102, the UE 102 uses the second antenna cluster 126 (e.g., any one or more of the antennas of the second antenna cluster 126) to perform transmission while the first antenna cluster 124 does not perform transmission.

The diagram 600 further illustrates a timeline for this behavior in terms of a Tx power graph 606. The Tx power graph 606 illustrates a use of antenna port switching 622 that is used to transition between the use of the first antenna cluster 124 and the use second antenna cluster 126.

Note generally that the diagram 600 corresponds to the case that each of the first antenna cluster 124 and the second antenna cluster 126 is understood to be operable according to independent (non-overlapping) SAR average value limits due to a sufficient separation distance 128 between the first antenna cluster 124 and the second antenna cluster 126.

The Tx power graph 606 illustrates a SAR averaging duration 608 (denoted T) which may be understood as the applicable Rx exposure duration for purposes of the SAR-related determinations under discussion with respect to FIG. 6. Note that in some embodiments, the SAR averaging duration 608 may be equal to 100 seconds.

In the example of the diagram 600, the first antenna cluster 124 and the second antenna cluster 126 have differing SAR characteristics. Accordingly, within the Tx power graph 606, a first Tx power level P_{SAR_CL1} 610 that corresponds to the SAR average value limit for the SAR averaging duration 608 that applies at the first antenna cluster 124 is shown. The P_{SAR_CL1}610 is a power level that, if fully used by the first antenna cluster 124 to perform transmission during the entire SAR averaging duration 608, would meet the SAR average value limit for the SAR averaging duration 608 for the first antenna cluster 124.

Further, a second Tx power level P_{SAR_CL2}612 that corresponds to the SAR average value limit for the SAR averaging duration 608 that applies at the second antenna cluster 126 is illustrated also illustrated. The P_{SAR_CL2}612 is a power level that, if fully used by the second antenna cluster 126 to perform transmission during the entire SAR averaging duration 608, would meet the SAR average value limit for the SAR averaging duration 608 for the second antenna cluster 126.

Note that because P_{SAR_CL1}610 is greater than P_{SAR_CL2}612, it will be understood that, from a same transmission power perspective, the first antenna cluster 124 accumulates SAR exposure at a slower rate than the second antenna cluster 126.

The Tx power graph 606 illustrates a first antenna cluster transmission power 618 and a second antenna cluster transmission power 620 as used over the SAR averaging duration 608. The Tx power graph 606 illustrates a case where the first antenna cluster 124 transmits over more than half and less than all of the SAR averaging duration 608 and does not perform transmission during the rest of the SAR averaging duration 608. Further, the second antenna cluster 126 transmits over less than half of the SAR averaging duration 608 and does not perform transmission during the rest of the SAR averaging duration 608.

Accordingly, as illustrated, it will be understood that the UE 102 will be in the first transmission state 602 (using the first antenna cluster 124 for transmission) during a first portion 614 of the SAR averaging duration 608 that is of a duration that is more than half of and less than all of the SAR averaging duration 608. An antenna port switching 622 from the first antenna cluster 124 to the second antenna cluster 126 is then triggered, with the result that the UE 102 will be in the second transmission state 604 (using the second antenna cluster 126 for transmission) during a second portion 616 of the SAR averaging duration 608 that is of a duration that is less than half of the SAR averaging duration 608.

As previously explained, because there is a sufficient separation distance 128 between the first antenna cluster 124 and the second antenna cluster 126, each of the first antenna cluster 124 and the second antenna cluster 126 can independently use up to the SAR average value limit during the SAR averaging duration 608. For example, in the case that the SAR average value limit is 1 W/kg, each of the first antenna cluster 124 and the second antenna cluster 126 can independently use up to 1 W/kg on average over the SAR averaging duration 208.

Accordingly, due to the fact the first antenna cluster 124 only actually transmits during the first portion 614 of the SAR averaging duration 608 (instead of over the entire SAR averaging duration 608), the first antenna cluster transmission power 618 can operate at a level that is greater than the P_{SAR_CL1}610 power level. Further, because the first portion 614 is of a duration that is more than half of the SAR averaging duration 608, the transmissions level is set under the 2x P_{SAR_CL1}626 power level during this time.

Further, due to the fact the second antenna cluster 126 also only actually transmits during the second portion 616 of the SAR averaging duration 608 (instead of over the entire SAR averaging duration 608), the second antenna cluster transmission power 620 can operate at a level that is greater than the P_{SAR_CL2} 612 power level. Further, because the second portion 616 is of a duration that is less than half of the SAR averaging duration 608, the transmission level is set above the 2x P_{SAR_CL2}624 power level during this time.

Note that under these circumstances, each of the first antenna cluster 124 and the second antenna cluster 126 has been independently operated within the constraints of the SAR average value limit when considered over the course of the entire applicable SAR averaging duration 608.

As can be seen in this example, due to the differing SAR characteristics of the first antenna cluster 124 and the second antenna cluster 126, a same power level may be used at the first antenna cluster 124 and the second antenna cluster 126 for different amounts of time. In other words, for a same transmission power level, an antenna cluster that accumulates SAR exposure more slowly (the first antenna cluster 124) can be used for longer relative to another antenna cluster that accumulates SAR exposure more quickly (the second antenna cluster 126).

Further, it will be understood that because the first antenna cluster transmission power 618 is above the P_{SAR_CL1}610 during the first portion 614 of the SAR averaging duration 608 and because the second antenna cluster transmission power 620 is above the P_{SAR_CL2}612 during the second portion 616 of the SAR averaging duration 608, UL throughput is improved over that which would otherwise be achieved in the case of an overlapped SAR average value limit that applies jointly to both the first antenna cluster 124 and the second antenna cluster 126.

Accordingly, it will be understood that through the use of the antenna port switching 622 between the first antenna cluster 124 and the second antenna cluster 126 as illustrated in FIG. 6, the UE 102 can beneficially leverage the use of SAR average values at each of the first antenna cluster 124 and the second antenna cluster 126 as available within each of the independent uses of the SAR average value limit for each of the first antenna cluster 124 and the second antenna cluster 126. Accordingly, the UE 102 experiences relatively improved UL Tx characteristics (improved/additional power and correspondingly UL throughput).

Finally, note that under the described arrangement, there is no need for Tx “downtime” within the SAR averaging duration 608 in order to remain compliant with the SAR average value limit at each of the first antenna cluster 124 and the second antenna cluster 126.

It is expressly considered that the portion interleaving as described elsewhere herein could be used in cases where antenna clusters have different applicable P_{SAR} values. For example, such a modified version of the diagram 600 may interleave the first portion 614 with the second portion 616.

Additionally or alternatively, it is also expressly considered that, for cases where antenna clusters have different applicable P_{SAR} values, the duration of portions of a SAR averaging duration during which each antenna cluster transmits could be adjusted away from the case of using the same power level at each portion, with corresponding adjustments made to power levels used during those adjusted portions, consistent with embodiments discussed herein.

For example, such a modified version of the diagram 600 may shorten the duration of the first portion 614 of the SAR averaging duration 608 from that which is illustrated while boosting the first antenna cluster transmission power 618 during the (shortened) first portion 614 above that which is illustrated. Correspondingly, the duration of the second portion 616 may be correspondingly lengthened beyond that which is illustrated, meaning that the second antenna cluster transmission power 620 would be moved correspondingly lower during the second portion 616 of the SAR averaging duration 608 than that which is illustrated.

With respect to various embodiments discussed herein, the selection by the UE of a Tx antenna to use (e.g., a determination of whether a particular Tx antenna is actively used for transmission within a corresponding antenna cluster) may depend on channel conditions as observed through that antenna.

Various examples provided herein relate to the case of a device using two antenna clusters having a sufficient separation distance between them to enable the independent use of a Rx exposure limit at each cluster. This presentation is for purposes of example and is not intended to be limiting. It will be understood that the principles discussed herein are extendable to cases of transmission behavior that occurs through more than two antenna clusters at a device that have sufficient separation distances.

In some cases, a UE may determine that the use of a particular antenna cluster is not desirable due to poor channel conditions through that antenna cluster. In such cases, the UE may fall back to the use of fewer cluster(s), using correspondingly lower Tx transmission powers such that the SAR average value limit is not breached through the uses at the cluster(s) that remain under active use for transmission purposes.

It is noted that while some discussion and examples provided herein are provided in terms of UEs of a wireless communication system (e.g., that are carried by/used in close proximity to a user), the principles herein are not limited solely to application at such UEs. Principles herein may be used, when applicable, for any type of device within the wireless communication system that is capable of transmission using multiple antennas.

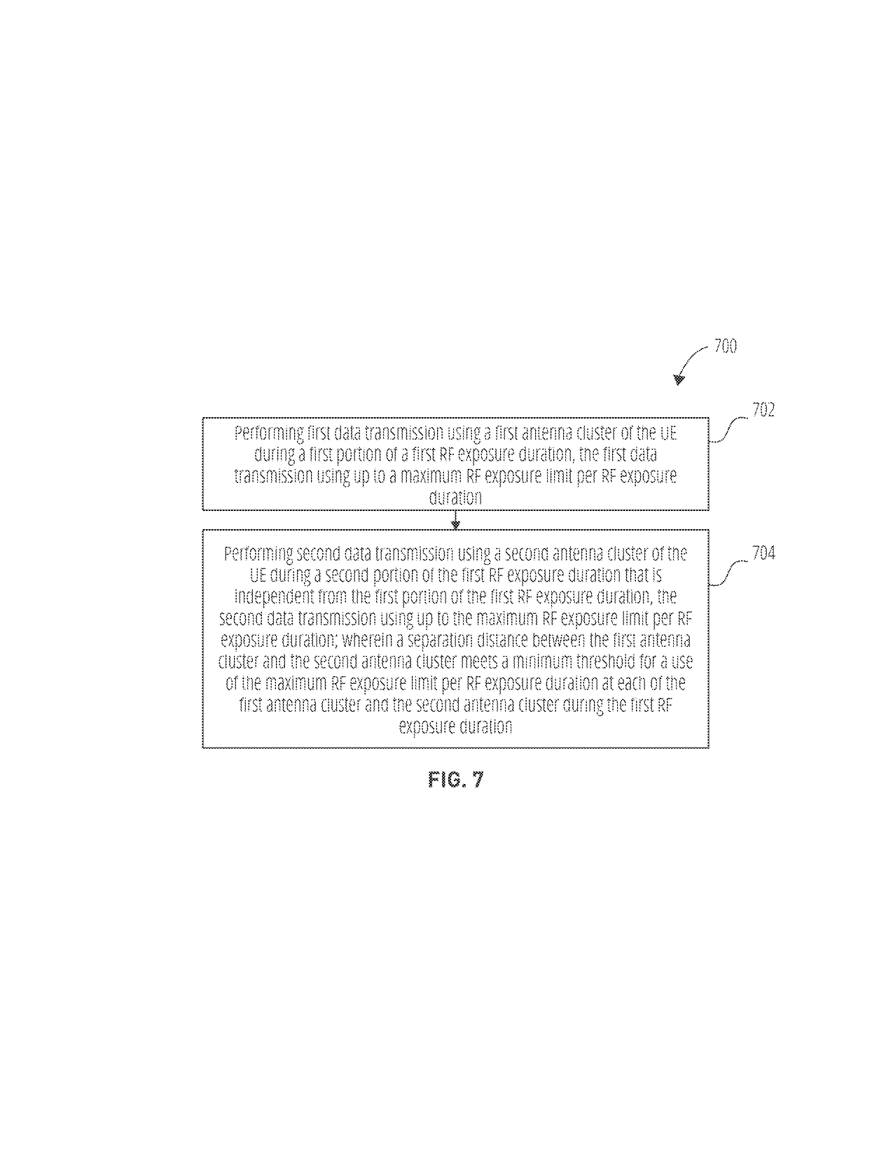

FIG. 7 illustrates a method 700 of a UE, according to embodiments discussed herein. The method 700 includes performing 702 performs first data transmission using a first antenna cluster of the UE during a first portion of a first RF exposure duration, the first data transmission using up to a maximum RF exposure limit per RF exposure duration. The method 700 further includes performing 704 second data transmission using a second antenna cluster of the UE during a second portion of the first RF exposure duration that is independent from the first portion of the first RF exposure duration, the second data transmission using up to the maximum RF exposure limit per RF exposure duration, wherein a separation distance between the first antenna cluster and the second antenna cluster meets a minimum threshold for a use of the maximum RF exposure limit per RF exposure duration at each of the first antenna cluster and the second antenna cluster during the first RF exposure duration.

In some embodiments, the method 700 further includes identifying the separation distance; and identifying that the separation distance between the first antenna cluster and the second antenna cluster meets the minimum threshold.

In some embodiments of the method 700, the first portion of the first RF exposure duration is of a different duration than the second portion of the first RF exposure duration.

In some embodiments of the method 700, the first data transmission is of a different power level than the second data transmission.

In some embodiments, the method 700 includes determining a duration of the first portion of the first RF exposure duration based on a channel quality of the first antenna cluster.

In some embodiments, the method 700 further includes determining, based on a channel condition for the first antenna cluster, not to use the first antenna cluster during a second RF exposure duration; and performing, in response to determining not to use the first antenna cluster during the second RF exposure duration, third data transmission with the second antenna cluster during an entirety of the second RF exposure duration, wherein the third transmission uses up to the maximum RF exposure limit per RF exposure duration.

In some embodiments of the method 700, wherein the first portion of the first RF exposure duration and the second portion of the first RF exposure duration are interleaved within the first RF exposure duration.

In some embodiments of the method 700, wherein the maximum RF exposure limit per RF exposure duration comprises a maximum specific absorption rate (SAR) average value.

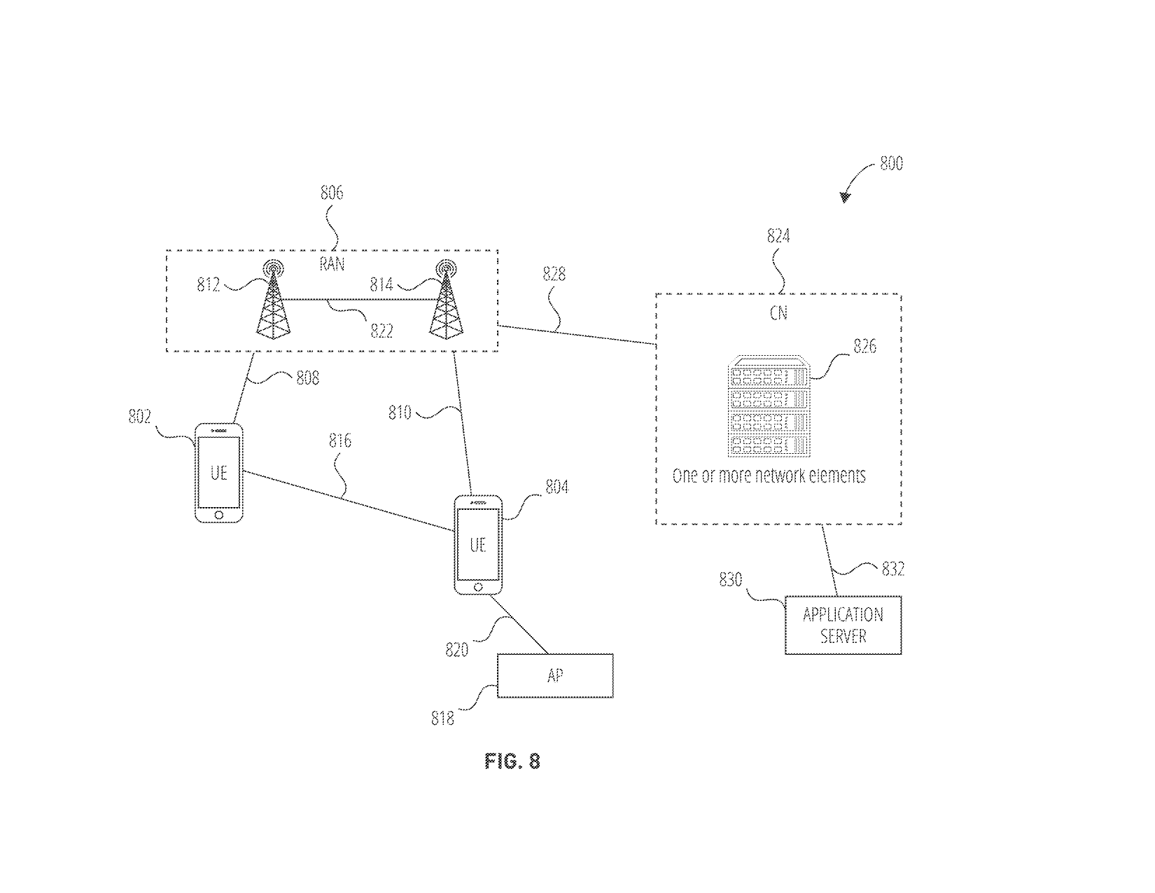

FIG. 8 illustrates an example architecture of a wireless communication system 800, according to embodiments disclosed herein. The following description is provided for an example wireless communication system 800 that operates in conjunction with the LTE system standards and/or 5G or NR system standards as provided by 3GPP technical specifications.

As shown by FIG. 8, the wireless communication system 800 includes UE 802 and UE 804 (although any number of UEs may be used). In this example, the UE 802 and the UE 804 are illustrated as smartphones (e.g., handheld touchscreen mobile computing devices connectable to one or more cellular networks), but may also comprise any mobile or non-mobile computing device configured for wireless communication.

The UE 802 and UE 804 may be configured to communicatively couple with a RAN 806. In embodiments, the RAN 806 may be NG-RAN, E-UTRAN, etc. The UE 802 and UE 804 utilize connections (or channels) (shown as connection 808 and connection 810, respectively) with the RAN 806, each of which comprises a physical communications interface. The RAN 806 can include one or more base stations (such as base station 812 and base station 814) that enable the connection 808 and connection 810.

In this example, the connection 808 and connection 810 are air interfaces to enable such communicative coupling, and may be consistent with RAT(s) used by the RAN 806, such as, for example, an LTE and/or NR.

In some embodiments, the UE 802 and UE 804 may also directly exchange communication data via a sidelink interface 816. The UE 804 is shown to be configured to access an access point (shown as AP 818) via connection 820. By way of example, the connection 820 can comprise a local wireless connection, such as a connection consistent with any IEEE 802.11 protocol, wherein the AP 818 may comprise a Wi-Fi^{®} router. In this example, the AP 818 may be connected to another network (for example, the Internet) without going through a CN 824.

In embodiments, the UE 802 and UE 804 can be configured to communicate using orthogonal frequency division multiplexing (OFDM) communication signals with each other or with the base station 812 and/or the base station 814 over a multicarrier communication channel in accordance with various communication techniques, such as, but not limited to, an orthogonal frequency division multiple access (OFDMA) communication technique (e.g., for downlink communications) or a single carrier frequency division multiple access (SC-FDMA) communication technique (e.g., for uplink and ProSe or sidelink communications), although the scope of the embodiments is not limited in this respect. The OFDM signals can comprise a plurality of orthogonal subcarriers.

In some embodiments, all or parts of the base station 812 or base station 814 may be implemented as one or more software entities running on server computers as part of a virtual network. In addition, or in other embodiments, the base station 812 or base station 814 may be configured to communicate with one another via interface 822. In embodiments where the wireless communication system 800 is an LTE system (e.g., when the CN 824 is an EPC), the interface 822 may be an X2 interface. The X2 interface may be defined between two or more base stations (e.g., two or more eNBs and the like) that connect to an EPC, and/or between two eNBs connecting to the EPC. In embodiments where the wireless communication system 800 is an NR system (e.g., when CN 824 is a 5GC), the interface 822 may be an Xn interface. The Xn interface is defined between two or more base stations (e.g., two or more gNBs and the like) that connect to 5GC, between a base station 812 (e.g., a gNB) connecting to 5GC and an eNB, and/or between two eNBs connecting to 5GC (e.g., CN 824).

The RAN 806 is shown to be communicatively coupled to the CN 824. The CN 824 may comprise one or more network elements 826, which are configured to offer various data and telecommunications services to customers/subscribers (e.g., users of UE 802 and UE 804) who are connected to the CN 824 via the RAN 806. The components of the CN 824 may be implemented in one physical device or separate physical devices including components to read and execute instructions from a machine-readable or computer-readable medium (e.g., a non-transitory machine-readable storage medium).

In embodiments, the CN 824 may be an EPC, and the RAN 806 may be connected with the CN 824 via an S1 interface 828. In embodiments, the S1 interface 828 may be split into two parts, an S1 user plane (S1-U) interface, which carries traffic data between the base station 812 or base station 814 and a serving gateway (S-GW), and the S1-MME interface, which is a signaling interface between the base station 812 or base station 814 and mobility management entities (MMEs).

In embodiments, the CN 824 may be a 5GC, and the RAN 806 may be connected with the CN 824 via an NG interface 828. In embodiments, the NG interface 828 may be split into two parts, an NG user plane (NG-U) interface, which carries traffic data between the base station 812 or base station 814 and a user plane function (UPF), and the S1 control plane (NG-C) interface, which is a signaling interface between the base station 812 or base station 814 and access and mobility management functions (AMFs).

Generally, an application server 830 may be an element offering applications that use internet protocol (IP) bearer resources with the CN 824 (e.g., packet switched data services). The application server 830 can also be configured to support one or more communication services (e.g., VoIP sessions, group communication sessions, etc.) for the UE 802 and UE 804 via the CN 824. The application server 830 may communicate with the CN 824 through an IP communications interface 832.

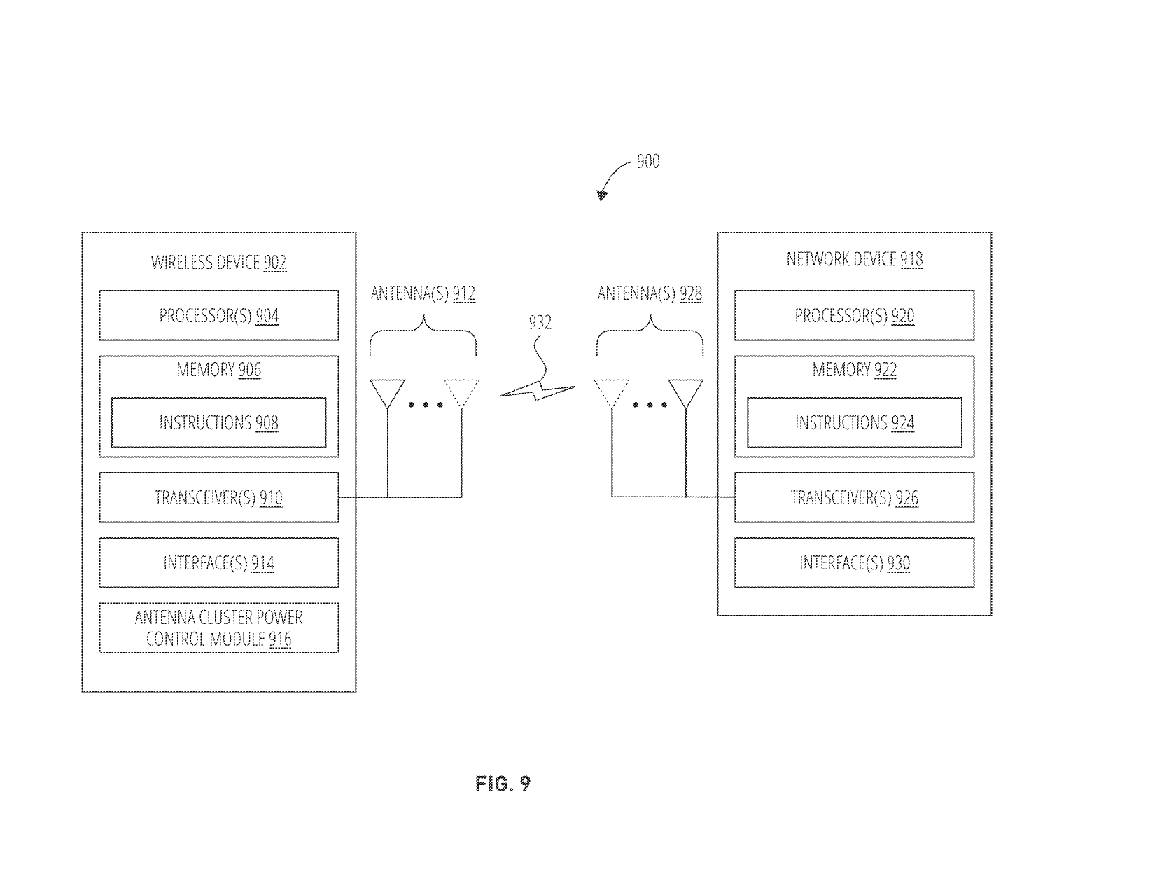

FIG. 9 illustrates a system 900 for performing signaling 932 between a wireless device 902 and a network device 918, according to embodiments disclosed herein. The system 900 may be a portion of a wireless communications system as herein described. The wireless device 902 may be, for example, a UE of a wireless communication system. The network device 918 may be, for example, a base station (e.g., an eNB or a gNB) of a wireless communication system.

The wireless device 902 may include one or more processor(s) 904. The processor(s) 904 may execute instructions such that various operations of the wireless device 902 are performed, as described herein. The processor(s) 904 may include one or more baseband processors implemented using, for example, a central processing unit (CPU), a digital signal processor (DSP), an application specific integrated circuit (ASIC), a controller, a field programmable gate array (FPGA) device, another hardware device, a firmware device, or any combination thereof configured to perform the operations described herein.

The wireless device 902 may include a memory 906. The memory 906 may be a non-transitory computer-readable storage medium that stores instructions 908 (which may include, for example, the instructions being executed by the processor(s) 904). The instructions 908 may also be referred to as program code or a computer program. The memory 906 may also store data used by, and results computed by, the processor(s) 904.

The wireless device 902 may include one or more transceiver(s) 910 that may include radio frequency (RF) transmitter circuitry and/or receiver circuitry that use the antenna(s) 912 of the wireless device 902 to facilitate signaling (e.g., the signaling 932) to and/or from the wireless device 902 with other devices (e.g., the network device 918) according to corresponding RATs.

The wireless device 902 may include one or more antenna(s) 912 (e.g., one, two, four, or more). For embodiments with multiple antenna(s) 912, the wireless device 902 may leverage the spatial diversity of such multiple antenna(s) 912 to send and/or receive multiple different data streams on the same time and frequency resources. This behavior may be referred to as, for example, multiple input multiple output (MIMO) behavior (referring to the multiple antennas used at each of a transmitting device and a receiving device that enable this aspect). MIMO transmissions by the wireless device 902 may be accomplished according to precoding (or digital beamforming) that is applied at the wireless device 902 that multiplexes the data streams across the antenna(s) 912 according to known or assumed channel characteristics such that each data stream is received with an appropriate signal strength relative to other streams and at a desired location in the spatial domain (e.g., the location of a receiver associated with that data stream). Certain embodiments may use single user MIMO (SU-MIMO) methods (where the data streams are all directed to a single receiver) and/or multi user MIMO (MU-MIMO) methods (where individual data streams may be directed to individual (different) receivers in different locations in the spatial domain).

In certain embodiments having multiple antennas, the wireless device 902 may implement analog beamforming techniques, whereby phases of the signals sent by the antenna(s) 912 are relatively adjusted such that the (joint) transmission of the antenna(s) 912 can be directed (this is sometimes referred to as beam steering).

The wireless device 902 may include one or more interface(s) 914. The interface(s) 914 may be used to provide input to or output from the wireless device 902. For example, a wireless device 902 that is a UE may include interface(s) 914 such as microphones, speakers, a touchscreen, buttons, and the like in order to allow for input and/or output to the UE by a user of the UE. Other interfaces of such a UE may be made up of transmitters, receivers, and other circuitry (e.g., other than the transceiver(s) 910/antenna(s) 912 already described) that allow for communication between the UE and other devices and may operate according to known protocols (e.g., Wi-Fi^{®}, Bluetooth®, and the like).

The wireless device 902 may include an antenna cluster power control module 916. The antenna cluster power control module 916 may be implemented via hardware, software, or combinations thereof. For example, the antenna cluster power control module 916 may be implemented as a processor, circuit, and/or instructions 908 stored in the memory 906 and executed by the processor(s) 904. In some examples, the antenna cluster power control module 916 may be integrated within the processor(s) 904 and/or the transceiver(s) 910. For example, the antenna cluster power control module 916 may be implemented by a combination of software components (e.g., executed by a DSP or a general processor) and hardware components (e.g., logic gates and circuitry) within the processor(s) 904 or the transceiver(s) 910.

The antenna cluster power control module 916 may be used for various aspects of the present disclosure, for example, aspects of FIG. 7. The antenna cluster power control module 916 nay configure the wireless device 902 to performing first data transmission using a first antenna cluster of the UE during a first portion of a first RF exposure duration, the first data transmission using up to a maximum RF exposure limit per RF exposure duration; and performing second data transmission using a second antenna cluster of the UE during a second portion of the first RF exposure duration that is independent from the first portion of the first RF exposure duration, the second data transmission using up to the maximum RF exposure limit per RF exposure duration; wherein a separation distance between the first antenna cluster and the second antenna cluster meets a minimum threshold for a use of the maximum RF exposure limit per RF exposure duration at each of the first antenna cluster and the second antenna cluster during the first RF exposure duration.

The network device 918 may include one or more processor(s) 920. The processor(s) 920 may execute instructions such that various operations of the network device 918 are performed, as described herein. The processor(s) 920 may include one or more baseband processors implemented using, for example, a CPU, a DSP, an ASIC, a controller, an FPGA device, another hardware device, a firmware device, or any combination thereof configured to perform the operations described herein.

The network device 918 may include a memory 922. The memory 922 may be a non-transitory computer-readable storage medium that stores instructions 924 (which may include, for example, the instructions being executed by the processor(s) 920). The instructions 924 may also be referred to as program code or a computer program. The memory 922 may also store data used by, and results computed by, the processor(s) 920.

The network device 918 may include one or more transceiver(s) 926 that may include RF transmitter circuitry and/or receiver circuitry that use the antenna(s) 928 of the network device 918 to facilitate signaling (e.g., the signaling 932) to and/or from the network device 918 with other devices (e.g., the wireless device 902) according to corresponding RATs.

The network device 918 may include one or more antenna(s) 928 (e.g., one, two, four, or more). In embodiments having multiple antenna(s) 928, the network device 918 may perform MIMO, digital beamforming, analog beamforming, beam steering, etc., as has been described.

The network device 918 may include one or more interface(s) 930. The interface(s) 930 may be used to provide input to or output from the network device 918. For example, a network device 918 that is a base station may include interface(s) 930 made up of transmitters, receivers, and other circuitry (e.g., other than the transceiver(s) 926/antenna(s) 928 already described) that enables the base station to communicate with other equipment in a core network, and/or that enables the base station to communicate with external networks, computers, databases, and the like for purposes of operations, administration, and maintenance of the base station or other equipment operably connected thereto.

Embodiments contemplated herein include an apparatus comprising means to perform one or more elements of the method 700. This apparatus may be, for example, an apparatus of a UE (such as a wireless device 902 that is a UE, as described herein).

Embodiments contemplated herein include one or more non-transitory computer-readable media comprising instructions to cause an electronic device, upon execution of the instructions by one or more processors of the electronic device, to perform one or more elements of the method 700. This non-transitory computer-readable media may be, for example, a memory of a UE (such as a memory 906 of a wireless device 902 that is a UE, as described herein).

Embodiments contemplated herein include an apparatus comprising logic, modules, or circuitry to perform one or more elements of the method 700. This apparatus may be, for example, an apparatus of a UE (such as a wireless device 902 that is a UE, as described herein).

Embodiments contemplated herein include an apparatus comprising: one or more processors and one or more computer-readable media comprising instructions that, when executed by the one or more processors, cause the one or more processors to perform one or more elements of the method 700. This apparatus may be, for example, an apparatus of a UE (such as a wireless device 902 that is a UE, as described herein).

Embodiments contemplated herein include a signal as described in or related to one or more elements of the method 700.

Embodiments contemplated herein include a computer program or computer program product comprising instructions, wherein execution of the program by a processor is to cause the processor to carry out one or more elements of the method 700. The processor may be a processor of a UE (such as a processor(s) 904 of a wireless device 902 that is a UE, as described herein). These instructions may be, for example, located in the processor and/or on a memory of the UE (such as a memory 906 of a wireless device 902 that is a UE, as described herein).

For one or more embodiments, at least one of the components set forth in one or more of the preceding figures may be configured to perform one or more operations, techniques, processes, and/or methods as set forth herein. For example, a baseband processor as described herein in connection with one or more of the preceding figures may be configured to operate in accordance with one or more of the examples set forth herein. For another example, circuitry associated with a UE, base station, network element, etc. as described above in connection with one or more of the preceding figures may be configured to operate in accordance with one or more of the examples set forth herein.

Any of the above described embodiments may be combined with any other embodiment (or combination of embodiments), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Embodiments and implementations of the systems and methods described herein may include various operations, which may be embodied in machine-executable instructions to be executed by a computer system. A computer system may include one or more general-purpose or special-purpose computers (or other electronic devices). The computer system may include hardware components that include specific logic for performing the operations or may include a combination of hardware, software, and/or firmware.

It should be recognized that the systems described herein include descriptions of specific embodiments. These embodiments can be combined into single systems, partially combined into other systems, split into multiple systems or divided or combined in other ways. In addition, it is contemplated that parameters, attributes, aspects, etc. of one embodiment can be used in another embodiment. The parameters, attributes, aspects, etc. are merely described in one or more embodiments for clarity, and it is recognized that the parameters, attributes, aspects, etc. can be combined with or substituted for parameters, attributes, aspects, etc. of another embodiment unless specifically disclaimed herein.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

Although the foregoing has been described in some detail for purposes of clarity, it will be apparent that certain changes and modifications may be made without departing from the principles thereof. It should be noted that there are many alternative ways of implementing both the processes and apparatuses described herein. Accordingly, the present embodiments are to be considered illustrative and not restrictive, and the description is not to be limited to the details given herein, but may be modified within the scope and equivalents of the appended claims.

1. A method of a user equipment (UE), comprising:
performing first data transmission using a first antenna cluster of the UE during a first portion of a first radio frequency (RF) exposure duration, the first data transmission using up to a maximum RF exposure limit per RF exposure duration; and
performing second data transmission using a second antenna cluster of the UE during a second portion of the first RF exposure duration that is independent from the first portion of the first RF exposure duration, the second data transmission using up to the maximum RF exposure limit per RF exposure duration;
wherein a separation distance between the first antenna cluster and the second antenna cluster meets a minimum threshold for a use of the maximum RF exposure limit per RF exposure duration at each of the first antenna cluster and the second antenna cluster during the first RF exposure duration.

2. The method of claim 1, further comprising:
identifying the separation distance; and
identifying that the separation distance between the first antenna cluster and the second antenna cluster meets the minimum threshold.

3. The method of claim 1, wherein the first portion of the first RF exposure duration is of a different duration than the second portion of the first RF exposure duration.

4. The method of claim 1, wherein the first data transmission is of a different power level than the second data transmission.

5. The method of claim 1, further comprising determining a duration of the first portion of the first RF exposure duration based on a channel quality of the first antenna cluster.

6. The method of claim 1, further comprising:
determining, based on a channel condition for the first antenna cluster, not to use the first antenna cluster during a second RF exposure duration; and
performing, in response to determining not to use the first antenna cluster during the second RF exposure duration, third data transmission with the second antenna cluster during an entirety of the second RF exposure duration, wherein the third transmission uses up to the maximum RF exposure limit per RF exposure duration.

7. The method of claim 1, wherein the first portion of the first RF exposure duration and the second portion of the first RF exposure duration are interleaved within the first RF exposure duration.

8. The method of claim 1, wherein the maximum RF exposure limit per RF exposure duration comprises a maximum specific absorption rate (SAR) average value.

9. An apparatus of a user equipment (UE), comprising:
one or more processors; and
a memory storing instructions that, when executed by the one or more processors, configure the apparatus to:
perform first data transmission using a first antenna cluster of the UE during a first portion of a first radio frequency (RF) exposure duration, the first data transmission using up to a maximum RF exposure limit per RF exposure duration; and
perform second data transmission using a second antenna cluster of the UE during a second portion of the first RF exposure duration that is independent from the first portion of the first RF exposure duration, the second data transmission using up to the maximum RF exposure limit per RF exposure duration;
wherein a separation distance between the first antenna cluster and the second antenna cluster meets a minimum threshold for a use of the maximum RF exposure limit per RF exposure duration at each of the first antenna cluster and the second antenna cluster during the first RF exposure duration.

10. The apparatus of claim 9, wherein the instructions, when executed by the one or more processors, further configure the apparatus to:
identify the separation distance; and
identify that the separation distance between the first antenna cluster and the second antenna cluster meets the minimum threshold.

11. The apparatus of claim 9, wherein the first portion of the first RF exposure duration is of a different duration than the second portion of the first RF exposure duration.

12. The apparatus of claim 9, wherein the first data transmission is of a different power level than the second data transmission.

13. The apparatus of claim 9, wherein the instructions, when executed by the one or more processors, further configure the apparatus to determine a duration of the first portion of the first RF exposure duration based on a channel quality of the first antenna cluster.

14. The apparatus of claim 9, wherein the instructions, when executed by the one or more processors, further configure the apparatus to:
determine, based on a channel condition for the first antenna cluster, not to use the first antenna cluster during a second RF exposure duration; and
perform, in response to determining not to use the first antenna cluster during the second RF exposure duration, third data transmission with the second antenna cluster during an entirety of the second RF exposure duration, wherein the third transmission uses up to the maximum RF exposure limit per RF exposure duration.

15. The apparatus of claim 9, wherein the first portion of the first RF exposure duration and the second portion of the first RF exposure duration are interleaved within the first RF exposure duration.

16. The apparatus of claim 9, wherein the maximum RF exposure limit per RF exposure duration comprises a maximum specific absorption rate (SAR) average value.

17. A non-transitory computer-readable storage medium including instructions that, when executed by a user equipment (UE), cause the UE to:
perform first data transmission using a first antenna cluster of the UE during a first portion of a first radio frequency (RF) exposure duration, the first data transmission using up to a maximum RF exposure limit per RF exposure duration; and
perform second data transmission using a second antenna cluster of the UE during a second portion of the first RF exposure duration that is independent from the first portion of the first RF exposure duration, the second data transmission using up to the maximum RF exposure limit per RF exposure duration;
wherein a separation distance between the first antenna cluster and the second antenna cluster meets a minimum threshold for a use of the maximum RF exposure limit per RF exposure duration at each of the first antenna cluster and the second antenna cluster during the first RF exposure duration.

18. The non-transitory computer-readable storage medium of claim 17, wherein the instructions, when executed by the UE, further cause the UE to:
identify the separation distance; and
identify that the separation distance between the first antenna cluster and the second antenna cluster meets the minimum threshold.

19. The non-transitory computer-readable storage medium of claim 17, wherein the first portion of the first RF exposure duration is of a different duration than the second portion of the first RF exposure duration.

20. The non-transitory computer-readable storage medium of claim 17, wherein the first portion of the first RF exposure duration and the second portion of the first RF exposure duration are interleaved within the first RF exposure duration.
